(19) United States
(12) Patent Application Publication
(10) Pub. No.: US 2025/0251275 A1
(43) Pub. Date: Aug. 7, 2025

(54) REDUCED FLUCTUATIONS AND INCREASED BRIGHTNESS UNIFORMITY OF LASER SUSTAINED PLASMA SOURCES

(71) Applicant: KLA Corporation, Milpitas, CA (US)

(72) Inventors: Deepak Kumar Batheja, Ann Arbor, MI (US); Vahid Esfandyarpour, San Jose, CA (US); John Fielden, Los Altos, CA (US)

(21) Appl. No.: 18/970,542

(22) Filed: Dec. 5, 2024

Related U.S. Application Data
(60) Provisional application No. 63/550,610, filed on Feb. 7, 2024.

(51) Int. Cl. G01J 1/04; G01J 1/44

(52) U.S. Cl. CPC G01J 1/0448; G01J 1/0414; G01J 1/44; G01J 2001/444

(57) ABSTRACT

An illumination source and method are disclosed for improving brightness uniformity. The illumination source may include a laser sustained plasma light source configured to generate a broadband light beam. The illumination source may include an adjustable reflector configured to be adjusted based on one or more signals indicative of a brightness distribution of the broadband light beam emitted along one or more directions. The illumination source may include a set of optics. The set of optics may be configured to split the broadband light beam into a first and second broadband light beam, invert the second broadband light beam, and recombine the first and second broadband light beam. The set of optics may be configured to image the illumination source at least twice, to receive a first and second broadband light beam and then combine the first and second broadband light beam.

### CROSS-REFERENCE TO RELATED APPLICATION

The present application claims the benefit under 35 U.S.C. § 119(e) of U.S. Provisional Application Ser. No. 63/550,610, filed Feb. 7, 2024, which is incorporated herein by reference in the entirety.

### TECHNICAL FIELD

The present disclosure relates generally to illumination sources, and, more particularly, to reducing spatial and/or temporal noise in brightness of a broadband light output from a plasma of an illumination source.

### BACKGROUND

Many semiconductor metrology and inspection tools use broadband light from plasma pumped by lasers.

While laser sustained plasma sources are considerably bright, they sometimes have fluctuating brightness. For example, the brightness may vary in intensity at a rate between 0.5 Hz to a few kHz. This fluctuation is typically caused by a turbulence in a flow of neutral gas around the plasma or the lamp house. This turbulence not only produces an apparent oscillation in the observed plasma location, but also causes fluctuating brightness. Additionally, pointing and power fluctuations in a pump laser may exacerbate these measured fluctuations from the plasma. The fluctuations limit the performance of the tool.

Conventional methods for reducing fluctuations of laser sustained plasma (LSP) sources include a feedback control loop to measure the fluctuation in the light output. The feedback controls the power of the laser based on the light output from the plasma to improve noise. However, a disadvantage of this method is reduced brightness. The light source is never operated at its peak intensity because of the requirement of being able to control the laser power to control the plasma brightness. Rather, the light source is operated in a “controllable” regime, below the peak intensity. Thus, a drawback of this method is that typically you must limit the source brightness to lower than the peak brightness. Additionally, this method only controls the temporal noise but not the uniformity of the plasma image. Another conventional method includes shining the laser light into the plasma vertically, so that the laser propagates in the direction opposite to gravity, and mounting the bulb horizontally, thereby reducing fluctuations in the light produced by the plasma. This method may impose relatively difficult constraints to the design geometry by limiting the orientation of the pump laser and other components.

There exists a desire for a system or method that reduces fluctuations present in, and/or increases brightness of, the light produced by laser pumped plasma illumination sources.

### SUMMARY

An illumination source is disclosed in accordance with one or more illustrative embodiments of the present disclosure. In one illustrative embodiment, the illumination source may include a laser sustained plasma light source configured to generate a broadband light beam. In another illustrative embodiment, the illumination source may include a detector. In another illustrative embodiment, the illumination source may include a set of optics including an adjustable reflector configured to receive and reflect the broadband light beam emitted from the laser sustained plasma light source. In another illustrative embodiment, the detector may be configured to detect a brightness distribution of the broadband light beam emitted by the laser sustained plasma light source along one or more directions. In another illustrative embodiment, the brightness distribution of the laser sustained plasma light source may correspond to fluctuations within a plasma of the laser sustained plasma light source. In another illustrative embodiment, the illumination source may include one or more controllers communicatively coupled to the detector and the adjustable reflector. In another illustrative embodiment, the one or more controllers may be configured to acquire, via the detector, one or more signals indicative of the brightness distribution of the broadband light beam emitted by the laser sustained plasma light source. In another illustrative embodiment, the one or more controllers may be configured to direct one or more feedback adjustments of the adjustable reflector based on the one or more signals.

In a further aspect, the illumination source may include a beamsplitter configured to receive the broadband light beam from the laser sustained plasma light source and split and direct less than 50% of the broadband light beam to the detector. In another aspect, the illumination source may include optical elements configured to collect the broadband light beam emitted from the laser sustained plasma light source from multiple angles and direct a portion of that light to the detector. In another aspect, the one or more feedback adjustments may include adjusting at least one of a shape or a direction of the adjustable reflector based on the one or more signals indicative of the brightness distribution of the broadband light beam along the one or more directions. In another aspect, the adjusting may be configured to maintain, via continuous feedback, a centroid of the brightness distribution at a particular position of a cross-sectional distribution of the broadband light beam.

In another aspect, the adjustable reflector may include an aimable reflector, where the directing of the one or more feedback adjustments of the adjustable reflector based on the one or more signals may include adjusting a direction of the aimable reflector using one or more actuators. In another aspect, the adjustable reflector may include a deformable mirror reflector, where the directing of the one or more feedback adjustments of the adjustable reflector based on the one or more signals may include adjusting a reflecting surface shape of the deformable mirror reflector. In another aspect, the adjustable reflector may include a digital micro-mirror device (DMD) including a plurality of DMD reflecting elements in an array, where the directing of the one or more feedback adjustments of the adjustable reflector based on the one or more signals may include selectively actuating the plurality of DMD reflecting elements.

In another aspect, the one or more directions may include two or more directions. In another aspect, the detector may include a diode array detector. In another aspect, the detector may include a quad-diode detector. In another aspect, the one or more controllers may include one or more proportional-integral-derivative (PID) controllers configured for the directing of the one or more feedback adjustments based on the one or more signals. In another aspect, the one or more controllers may be further configured to direct one or more non-reflector feedback adjustments including an adjustment of a power supply configured to adjust a power level supplied to a laser source of the laser sustained plasma light source based on the one or more signals.

An illumination source is disclosed in accordance with one or more illustrative embodiments of the present disclosure. In one illustrative embodiment, the illumination source may include a laser sustained plasma light source configured to generate a broadband light beam. In another illustrative embodiment, the illumination source may include a set of optics. In another illustrative embodiment, the set of optics may include a beamsplitter configured to receive the broadband light beam and split it into a first broadband light beam having a first light orientation and a second broadband light beam having a second light orientation. In another illustrative embodiment, the set of optics may include one or more inverting optics configured to invert the second light orientation of the second broadband light beam to be an inverted second light orientation. In another illustrative embodiment, the set of optics may include one or more recombining optics configured to recombine the first broadband light beam having the first light orientation and the second broadband light beam having the inverted second light orientation.

In a further aspect, the one or more recombining optics may include a second beamsplitter configured to recombine. In another aspect, the illumination source may include a compensating device placed in a path of at least one of the first broadband light beam or the second broadband light beam. In another aspect, the compensating device may be configured to alter a relative strength of at least one of the first broadband light beam or the second broadband light beam.

An illumination source is disclosed in accordance with one or more illustrative embodiments of the present disclosure. In one illustrative embodiment, the illumination source may include a laser sustained plasma light source configured to generate a first broadband light beam and a second broadband light beam. In another illustrative embodiment, the illumination source may include a set of optics. In another illustrative embodiment, the set of optics may include one or more first optics configured to receive the first broadband light beam. In another illustrative embodiment, the set of optics may include one or more second optics configured to receive the second broadband light beam, where the second broadband light beam is distinct from the first broadband light beam but configured to be received from the same laser sustained plasma light source as the first broadband light beam. In another illustrative embodiment, the set of optics may include one or more combining optics configured to combine the first broadband light beam and the second broadband light beam.

In a further aspect, the one or more combining optics may include a beamsplitter. In another aspect, a split-off portion otherwise discarded from the beamsplitter may be configured, via a redirecting element, to be redirected back into the beamsplitter and back through a plasma of the laser sustained plasma light source.

A characterization system is disclosed in accordance with one or more illustrative embodiments of the present disclosure. In one illustrative embodiment, the characterization system may include an illumination source configured to provide a broadband light beam to a sample. In another illustrative embodiment, the characterization system may include a detector assembly configured to image the sample. In another illustrative embodiment, the illumination source may include a laser sustained plasma light source configured to generate the broadband light beam. In another illustrative embodiment, the illumination source may include a detector. In another illustrative embodiment, the illumination source may include a set of optics comprising an adjustable reflector, where the adjustable reflector may be configured to receive and reflect the broadband light beam emitted from the laser sustained plasma light source. In another illustrative embodiment, the detector may be configured to detect a brightness distribution of the broadband light beam emitted by the laser sustained plasma light source along one or more directions, where the brightness distribution of the laser sustained plasma light source corresponds to fluctuations within a plasma of the laser sustained plasma light source. In another illustrative embodiment, the characterization system may include one or more controllers communicatively coupled to the detector and the adjustable reflector.

In a further aspect, the one or more controllers may be configured to acquire, via the detector, one or more signals indicative of the brightness distribution of the broadband light beam emitted by the laser sustained plasma light source. In another aspect, the one or more controllers may be configured to direct one or more feedback adjustments of the adjustable reflector based on the one or more signals.

A characterization system is disclosed in accordance with one or more illustrative embodiments of the present disclosure. In one illustrative embodiment, the characterization system may be configured to improve uniformity of illumination. In another illustrative embodiment, the characterization system may include an illumination source configured to provide a broadband light beam to a sample. In another illustrative embodiment, the characterization system may include a detector assembly configured to image the sample. In another illustrative embodiment, the illumination source may include a laser sustained plasma light source configured to generate the broadband light beam. In another illustrative embodiment, the illumination source may include a set of optics. In another illustrative embodiment, the set of optics may include a beamsplitter configured to receive the broadband light beam from the laser sustained plasma light source and split the broadband light beam into a first broadband light beam having a first light orientation and a second broadband light beam having a second light orientation. In another illustrative embodiment, the set of optics may include one or more inverting optics configured to invert the second light orientation of the second broadband light beam to be an inverted second light orientation. In another illustrative embodiment, the set of optics may include one or more recombining optics configured to recombine the first broadband light beam having the first light orientation and the second broadband light beam having the inverted second light orientation.

A characterization system is disclosed in accordance with one or more illustrative embodiments of the present disclosure. In one illustrative embodiment, the characterization system may be configured to improve uniformity of illumination. In another illustrative embodiment, the characterization system may include an illumination source configured to provide broadband light to a sample. In another illustrative embodiment, the characterization system may include a detector assembly configured to image the sample. In another illustrative embodiment, the illumination source may include a laser sustained plasma light source configured to generate a first broadband light beam and a second broadband light beam. In another illustrative embodiment, the illumination source may include a set of optics. In another illustrative embodiment, the set of optics may include one or more first optics configured to receive the first broadband light beam. In another illustrative embodiment, the set of optics may include one or more second optics configured to receive the second broadband light beam, where the second broadband light beam is distinct from the first broadband light beam but configured to be received from the same laser sustained plasma light source as the first broadband light beam. In another illustrative embodiment, the set of optics may include one or more combining optics configured to combine the first broadband light beam and the second broadband light beam.

A method is disclosed in accordance with one or more illustrative embodiments of the present disclosure. In one illustrative embodiment, the method may include generating a broadband light beam with a laser sustained plasma light source of an illumination source. In another illustrative embodiment, the method may include acquiring, via a detector, one or more signals indicative of a brightness distribution of the broadband light beam emitted by the laser sustained plasma light source, where the brightness distribution is along one or more directions. In another illustrative embodiment, the method may include directing, via one or more controllers communicatively coupled to the detector and an adjustable reflector, one or more feedback adjustments of the adjustable reflector based on the one or more signals.

A method is disclosed in accordance with one or more illustrative embodiments of the present disclosure. In one illustrative embodiment, the method may include generating a broadband light beam with a laser sustained plasma light source of an illumination source. In another illustrative embodiment, the method may include splitting, via a beamsplitter of the illumination source, the broadband light beam into a first broadband light beam and a second broadband light beam. In another illustrative embodiment, the method may include inverting, via one or more inverting optics of the illumination source, a second light orientation of the second broadband light beam to be an inverted second light orientation. In another illustrative embodiment, the method may include recombining, via recombining optics of the illumination source, the first broadband light beam and the second broadband light beam having the inverted second light orientation.

A method is disclosed in accordance with one or more illustrative embodiments of the present disclosure. In one illustrative embodiment, the method may include generating a first broadband light beam and a second broadband light beam with a laser sustained plasma light source of an illumination source. In another illustrative embodiment, the method may include combining, via combining optics comprising a beamsplitter, the first broadband light beam and the second broadband light beam as a single combined broadband light beam. In another illustrative embodiment, the method may include illuminating a sample with the single combined broadband light beam.

It is to be understood that both the foregoing general description and the following detailed description are exemplary and explanatory only and are not necessarily restrictive of the invention as claimed. The accompanying drawings, which are incorporated in and constitute a part of the specification, illustrate embodiments of the invention and together with the general description, serve to explain the principles of the invention.

### BRIEF DESCRIPTION OF THE DRAWINGS

The numerous advantages of the disclosure may be better understood by those skilled in the art by reference to the accompanying figures.

FIG. 1 illustrates a conceptual view of a characterization system for improving illumination, in accordance with one or more embodiments of the present disclosure.

FIG. 2 illustrates a schematic view of an illumination source including a set of optics configured for feedback adjustments of an aimable reflector, in accordance with one or more embodiments of the present disclosure.

FIG. 3 illustrates a schematic view of an illumination source including a set of optics configured for feedback adjustments of an adjustable reflector, in accordance with one or more embodiments of the present disclosure.

FIG. 4 illustrates a schematic view of an illumination source including a set of optics configured for splitting and recombining broadband light for improved uniformity, in accordance with one or more embodiments of the present disclosure.

FIG. 5 illustrates a schematic view of an illumination source including a set of optics configured for imaging a plasma twice and combining a first and second broadband light for improved uniformity, in accordance with one or more embodiments of the present disclosure.

FIG. 6 illustrates a simplified block diagram of a characterization system, in accordance with one or more embodiments of the present disclosure.

FIG. 7 illustrates a process flow diagram depicting a method for actively reducing the noise or increasing the uniformity of illumination, in accordance with one or more embodiments of the present disclosure.

FIG. 8 illustrates a process flow diagram depicting a method for improving uniformity of illumination, in accordance with one or more embodiments of the present disclosure.

FIG. 9 illustrates a process flow diagram depicting a method for improving uniformity of illumination, in accordance with one or more embodiments of the present disclosure.

FIG. 10 illustrates a data graph of plasma movement and brightness fluctuations over time, in accordance with one or more embodiments of the present disclosure.

### DETAILED DESCRIPTION

The present disclosure has been particularly shown and described with respect to certain embodiments and specific features thereof. The embodiments set forth herein are taken to be illustrative rather than limiting. It should be readily apparent to those of ordinary skill in the art that various changes and modifications in form and detail may be made without departing from the spirit and scope of the disclosure. Reference will now be made in detail to the subject matter disclosed, which is illustrated in the accompanying drawings.

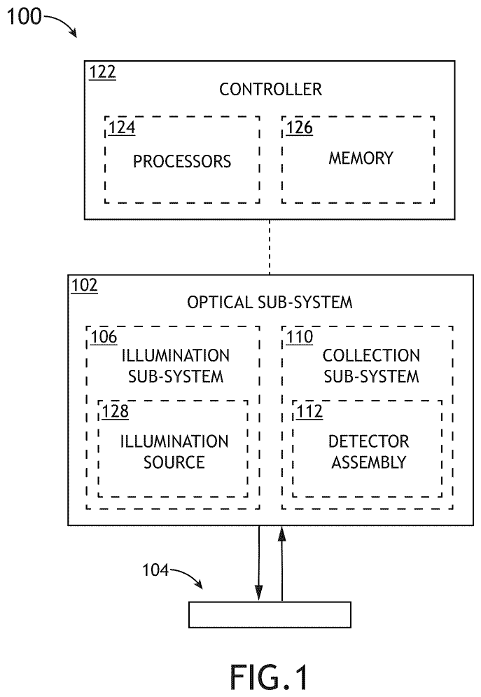

Referring to FIGS. 1 through 9, systems and methods for reducing spatial and/or temporal noise in brightness of a broadband light beam of a laser sustained plasma (LSP) light source are disclosed, in accordance with one or more embodiments of the present disclosure.

Embodiments of the present disclosure are directed to an illumination source and methods to configure light collection and manipulation to reduce brightness fluctuations and improve uniformity of the broadband light emitted by the LSP light source. In embodiments, active adjustable optics and/or passive averaging optics are used to correct for temporal and/or spatial noise present in the brightness distribution produced by the LSP light source of the illumination source.

For purposes of the present disclosure, “brightness distribution” includes spatial and temporal brightness distribution. For example, the brightness distribution may be recorded over a period of time and over one or more spatial directions.

In embodiments, a set of optics of the illumination source when in an active configuration include an adjustable reflector to be used in tandem with a detector (e.g., a quad-diode detector) to adjust a brightness distribution of the broadband light beam received/imaged from the LSP light source. For example, an adjustable reflector may include, but is not limited to, an aimable reflector, deformable reflector, digital micro-mirror device (DMD) reflector, spatial light modulator, or the like. In this way, for example, the adjustable reflector may be used to adjust for fluctuations in brightness caused by turbulence. For instance, the turbulence may produce an oscillation in the observed plasma location. For instance, the adjustable reflector may be aimed and/or deformed to correct for the movement in the observed plasma location.

In embodiments, a set of optics of the illumination source when in a passive configuration include passive elements that invert one broadband light beam and combine it with a different broadband light beam from the same LSP light source. In this regard, the combined broadband light beam has improved uniformity relative to a single broadband light beam with a single orientation. In this way, for example, slightly brighter or darker spots or fluctuations near a top of the brightness distribution of an output of the LSP source are averaged with a lower portion of the brightness distribution.

Embodiments of the present disclosure may improve the uniformity of the plasma image of the LSP light source, without requiring reduced peak brightness or particular orientations of the laser source of the LSP light source. It is noted that systems and methodologies herein may be configured to be combined with conventional methods mentioned above and/or combined with each other for further improving brightness distributions. The lower fluctuations and improved uniformity afforded by embodiments of the present disclosure may improve the performance of tools, such as increasing accuracy of inspection system measurements or overlay metrology system measurements using LSP light sources.

Furthermore, inspection and metrology tools, which do not use a homogenizer, may have stringent conditions on the uniform area of the light covering the illumination pupil or aperture. This often requires a large uniform plasma image. Meeting this uniformity requirement may be impractical without reducing the brightness of the plasma. In embodiments of the present disclosure, a set of optics of the illumination source may be used to improve the uniformity of the plasma image, without reducing the brightness.

FIG. 1 illustrates a conceptual view of a characterization system 100 for improving illumination, in accordance with one or more embodiments of the present disclosure.

The characterization system 100 may include an optical sub-system 102 and a controller 122 communicatively coupled to the optical sub-system 102. In embodiments, the controller 122 includes one or more processors 124 and memory 126. In embodiments, the optical sub-system 102 is configured to perform measurements on sample 104. In embodiments, the optical sub-system 102 includes an illumination sub-system 106 and a collection sub-system 110.

In embodiments, the illumination sub-system 106 includes an illumination source 128. The illumination source 128 may include an LSP light source and one or more optical elements for reducing spatial and/or temporal noise in the broadband light beam of the LSP light source.

In embodiments, the illumination sub-system 106 includes one or more optical components suitable for modifying and/or conditioning the broadband light beam as well as directing the broadband light beam to the sample 104.

The collection sub-system 110 may include a detector assembly 112 configured to image a sample 104. The detector assembly 112 may include any detector assembly known in the art of inspection or metrology. For example, the detector assembly 112 may include, but is not limited to, photodiodes (e.g., two or more photodiodes). By way of another example, the detector assembly 112 may include, but is not limited to, a multi-pixel detector such as a complementary metal-oxide semiconductor (CMOS) detector, a charge-coupled device (CCD) detector, or the like.

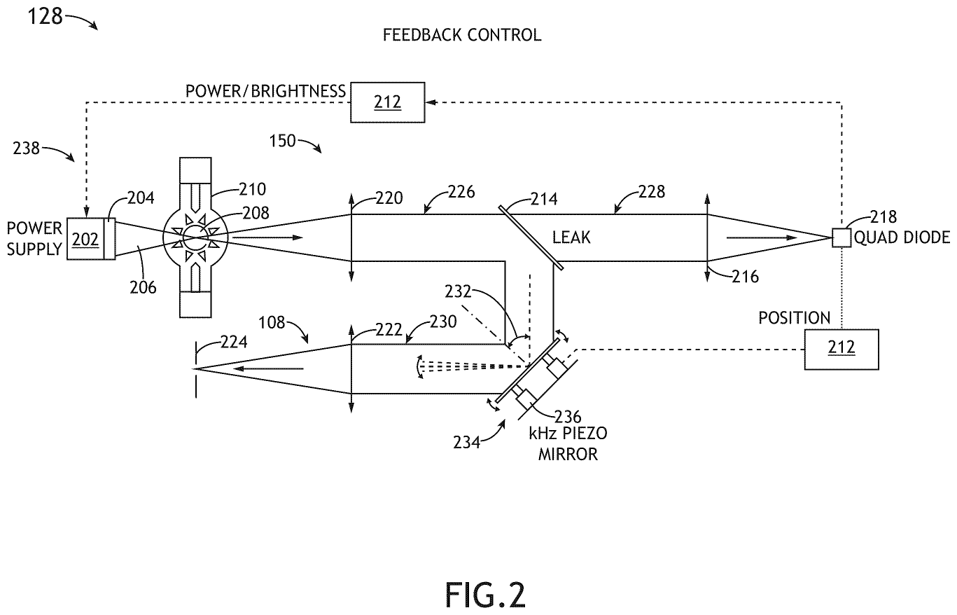

FIGS. 2 through 5 illustrate the illumination source 128, in accordance with embodiments of the present disclosure. In embodiments, the illumination source 128 includes the LSP light source 238 and a set of optics 150. Note that the configurations and figures shown are non-limiting and shown for illustrative purposes only and a variety of configurations for correcting light beams may be used.

The illumination source 128 may include any type of LSP light source suitable for providing a broadband light beam 108. The LSP light source 238 may include a gas containment structure 210 configured for containing a selected gas. The gas containment structure 210 may include any gas containment structure known in the art of LSP light sources including, but not limited to, a bulb, a cell, or a chamber. The gas containment structure 210 may contain any gas known in the art of LSP light sources including, but not limited to, xenon or argon.

The LSP light source 238 may include a laser source 204 configured to generate one or more laser beams 206 for sustaining the plasma 208 within the gas containment structure 210. The illumination source 128 may include a power supply 202 configured to power the laser source 204. For example, the power supply 202 may be configured to adjust the power level of the one or more laser beams 206 to regulate the brightness of the LSP light source 238.

Referring to FIG. 2, the adjustable reflector 234 may include an aimable reflector, in accordance with one or more embodiments of the present disclosure. The aimable reflector may include any aimable reflector known in the art such as, but not limited to, a curved or flat mirror configured such that a direction of light reflected from the aimable reflector is controllable in a particular direction.

The adjustable reflector 234 may allow for correcting for fluctuations in brightness caused by oscillations in the location of the plasma 208. The adjustable reflector 234 may be configured to receive and reflect broadband light emitted from the LSP light source 238.

In embodiments, the illumination source 128 further includes one or more controllers 212 and a detector 218. In this way, the illumination source 128 may be configured to monitor the brightness distribution of the broadband light beam of the plasma 208 using the detector 218, and make adjustments to the adjustable reflector 234 to compensate for changes to the brightness distribution of the broadband light beam of the plasma 208. For instance, the adjustable reflector 234 may include a mirror that is controlled, using controller 212, in a feedback control loop to compensate for movement or perceived movement of the plasma 208.

The broadband light beam 226 may display the brightness distribution indicative of fluctuations within the plasma 208 of the LSP light source 238. The plasma fluctuations may be caused by actual movement of the plasma 208 or perceived motion of the plasma 208 caused by distortions in gases around the plasma 208.

The illumination source 128 may be configured for measuring the perceived brightness distribution of the broadband light beam 226 using one or more methods. For example, the set of optics 150 may include a beamsplitter 214 configured to receive the broadband light beam 226 from the LSP light source 238, and split and direct less than 50% (leak) of the broadband light beam 226 to the detector 218. In this way, a fraction of the broadband light beam 226 may be directed to the detector 218 while most (e.g., more than 50%) of the broadband light beam 226 may be directed towards the collection aperture 224. For instance, the fraction of the broadband light that is detected may be a small fraction (e.g., much less than 50%). The beam splitter 214 may include an uncoated optic or an optic coated for a specific wavelength range.

For example, the broadband light beam 226 may be collected with the collection optics 220 (e.g., a lens), and split by the beamsplitter 214. For example, the leak may be small, less than 5% of brightness of the broadband light beam 226. The brightness distribution may be measured at or near a field plane.

Alternatively, the illumination source 128 may include optical elements configured to collect broadband light beams emitted from the LSP light source 238 from two or more different angles and direct a portion of that light to the detector 218. For instance, the optical elements (not shown) may collect a secondary measurement broadband light beam (not shown) and direct the secondary measurement broadband light beam to the detector 218.

The rest of the remaining broadband light beam 230 may be directed by the beamsplitter 214 along a path to the adjustable reflector 234. Note that the figures shown and described herein are nonlimiting, unless otherwise noted, and are shown for simplicity purposes only. For example, the paths are not necessarily simple and straight and any number of intermediate elements (e.g., optical lens, reflectors, polarizers, filters, etc.) may be used between any elements shown. The adjustable reflector 234 may be located at any location in the path of broadband light beam 230 or the like.

Note that, for purposes of the present disclosure, that the incident angle 232 of any beam (e.g., broadband light beam 230) being reflected may be shown in the figures as 45 degrees or the like but that this is nonlimiting and shown for clarity purposes only. In embodiments, any incident angle 232 may be configured to be 20 degrees or less (e.g., 15 degrees or less) so as to preserve polarization of the beams.

The detector 218 may be configured to detect the brightness distribution of the broadband light beam 226 along one or more directions. For example, the one or more dimensions may include a first and/or second direction (e.g., X and Y direction) in two-dimensional space, as viewed by the detector 218. For instance, the first and second directions may be, respectively, vertical and horizontal perceived movements of the plasma 208 within the gas containment structure 210. For example, the one or more dimensions may include two or more dimensions that are orthogonal to each other. For example, the two directions may be orthogonal (or nearly orthogonal) to a travel direction of the leaked broadband light beam 228, such that the travel direction of the leaked broadband light beam 228 as incident on the detector 218 may be referred to as a third direction.

The detector 218 may include any detector such as, but not limited to, a photo diode array detector, a quad-diode detector, a fast-imaging diode detector, a high-rate camera, and/or the like. For example, detector 218 may include a diode array detector. For example, detector 218 may include a quad-diode detector.

The detector 218 may be configured to detect relative spatial brightness levels detected by spatially separated sensors. For example, the quad-diode detector may include four photo-diodes spatially configured in a two-by-two arrangement for measuring the perceived movement of the plasma 208 in two orthogonal directions. For instance, as the plasma 208 moves to the left, the corresponding diodes may detect an increase in brightness. In this way, the quad-diode detector may may detect the location of the center of brightness of plasma 208.

The one or more controllers 212 may be communicatively coupled to the detector 218 and the adjustable reflector 234. The one or more controllers 212 may be configured to acquire one or more signals indicative of the broadband light beam 226 using the detector 218. The one or more signals may be indicative of the brightness distribution of the broadband light beam along the one or more directions. The one or more controllers 212 may be configured to direct one or more feedback adjustments of the adjustable reflector 234 based on the one or more signals.

The one or more controllers 212 may include one or more proportional-integral-derivative (PID) controllers configured for directing the feedback adjustments based on the one or more signals.

The one or more feedback adjustments may include adjusting at least one of a reflecting surface shape or a direction of the adjustable reflector 234 based on the one or more signals indicative of the brightness distribution of the broadband light beam 226 along the one or more directions.

The adjusting may be configured to maintain, via continuous feedback, a centroid of the brightness distribution at a particular position (e.g., center) of a cross-sectional distribution of the broadband light beam 226. For example, in a simplified configuration, if upper diodes detect relatively brighter light than lower diodes, then the adjustable reflector 234 may be configured to adjust the adjustable reflector 234 such that the portion of the broadband light beam 230 corresponding to the brighter detection is aimed more towards a center of a pathway, to provide for a more centered brightness distribution. This may be configured to be performed continuously, in real time, as a feedback control loop.

Directing the feedback adjustments may include using one or more actuators 236 to adjust a direction of the aimable reflector 234. For example, the aimable reflector 234 may include one or more actuators 236 coupled to a reflecting surface of the aimable reflector 234. For example, the one or more actuators 236 may include piezoelectric actuators. For example, the actuators 236 may include piezoelectric actuators with a bandwidth in the kilohertz (KHz) range. For example, the aimable reflector 234 may include a 2-axis piezo-actuated mirror, configured to compensate the pointing up to a frequency of several kHz. The actuators 236 may be coupled to the controller 212 and used to adjust the direction of the aimable reflector 234 by rotating the aimable reflector 234. For instance, as shown, the actuators 236 may be non-parallel to the reflecting surface of the aimable reflector 234. The aimable reflector 234 may compensate for a change in the position of the plasma, which will increase the temporal uniformity of the brightness at the illumination beam collection aperture 224.

In embodiments, the illumination source 128 includes measurement optics 216. For example, the measurement optics 216 may include a lens for imaging the leaked broadband light beam 228 upon the detector 218.

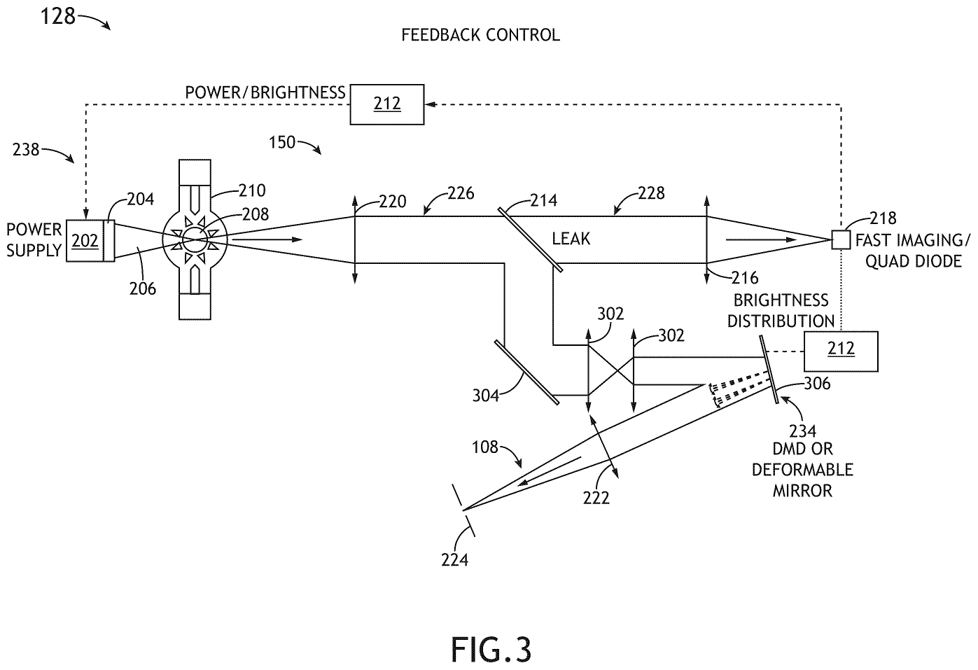

Referring to FIG. 3, the adjustable reflector 234 may include a deformable mirror reflector, digital micro-mirror device (DMD), or spatial light modulator (SLM), in accordance with one or more embodiments of the present disclosure. FIG. 3 may be an alternative to FIG. 2.

In embodiments, the feedback adjustments of the adjustable reflector 234 may include adjusting a reflecting surface shape of the adjustable reflector 234. In this way, the adjustable reflector 234 may include a deformable mirror reflector. For example, the deformable mirror reflector may include a non-rigid (e.g., flexible) reflecting surface 306 configured to be adjusted using actuators (not shown). For example, a grid of actuators on a backside of the reflecting surface 306 may be used to provide a variety of surface shapes for relatively precise control of light redirected from the reflecting surface 306.

In embodiments, the adjustable reflector 234 may include a digital micro-mirror device (DMD) including a plurality of DMD reflecting elements in an array.

The DMD, or deformable reflector, may re-arrange the light from different regions of the imaging aperture to create a more uniform plasma image at the illumination beam collection aperture 224. This feedback adjustment may be based on signals from the detector 218 that are indicative of spatial non-uniformity of the brightness distribution.

In embodiments, the directing of the one or more feedback adjustments of the adjustable reflector 234 based on one or more signals includes selectively actuating the plurality of DMD reflecting elements. For example, the DMD reflecting elements may be configured to be selectively activated or selectively aimed to reflect the broadband light beam towards optics 222, 224. By way of another example, the DMD reflecting elements may be configured to be selectively deactivated to prevent reflection towards optics 222, 224, and to discard the light. For example, if a portion of the brightness distribution is relatively brighter than a different portion, then the controller 212 may be configured to at least one of: selectively aim or deactivate one or more DMD reflecting elements corresponding to the portion to provide for a more uniform brightness distribution.

The adjustable reflector 234 may be placed at a convenient location in a light path of the broadband light beam, including, but not limited to, at or near a pupil plane or at or near an intermediate focus. In embodiments, the angle of incidence on the adjustable reflector 234 may be configured to be small (e.g., less than 20 degrees) to maintain the polarization of the light.

In embodiments, the set of optics 150 may include resizing optics 302 configured to invert and/or shrink a size of the broadband light beam 226. For example, the resizing optics 302 may include paired optical elements for resizing. As shown, the resizing optics 302 may also be configured for beam inversion.

Furthermore, the set of optics 150 may include one or more additional elements such as a second reflector 304 configured to direct the broadband light beam 226 toward the adjustable reflector 234.

As shown in FIGS. 2 and 3, the one or more controllers 212 may be further configured to direct one or more non-reflector feedback adjustments. The one or more non-reflector feedback adjustments may include an adjustment of the power supply 202 configured to adjust a power level supplied to the laser source 204 of the LSP light source 238 based on the one or more signals. For example, the controller 212 may be configured to direct one or more non-reflector feedback adjustments configured to reduce a brightness of the broadband light beam. The non-reflector feedback adjust may be based on an overall temporal brightness of the brightness distribution of the one or more signals increasing above a threshold.

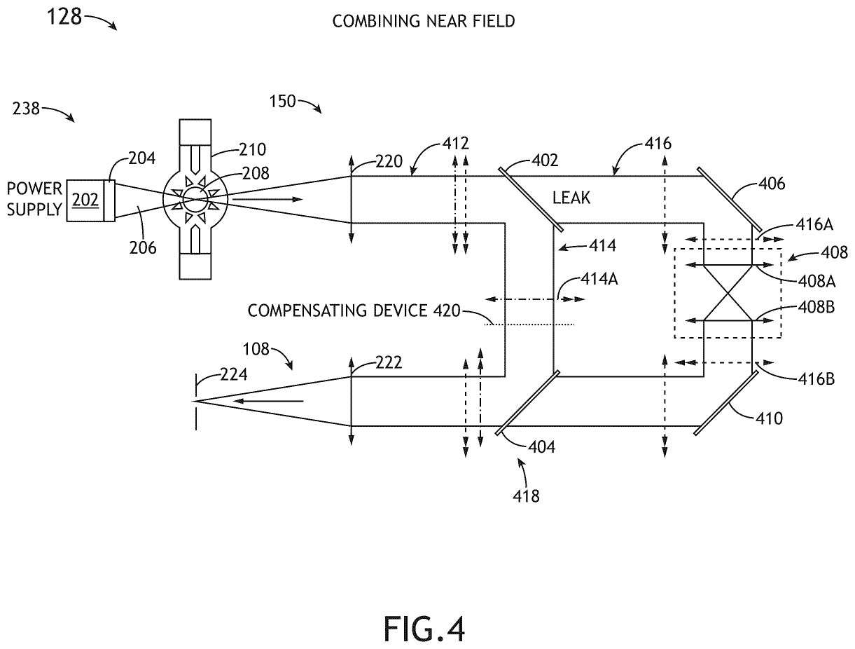

FIG. 4 illustrates a schematic view of the illumination source 128 including a set of optics 150 configured for splitting and recombining broadband light for improved uniformity, in accordance with one or more embodiments of the present disclosure. Fluctuations in the measured brightness may be caused by turbulent and random flow of neutral gas around the plasma or around the bulb. Averaging brightness reduces the random fluctuations. In embodiments, the near field may be combined to average the broadband light beam and improve spatial uniformity in the horizontal and/or vertical directions. The broadband light beam may be split, with one half inverted and recombined so that slightly brighter and darker spots are averaged out and reduced.

In embodiments, the illumination source 128 includes a beamsplitter 402, inverting optics 408, and recombining optics 418. In this way, roughly one half of the broadband light beam 412 may be configured to be split off, inverted, and then recombined with the other half, to average out the brightness distribution of the broadband light beam.

The beamsplitter 402 may be configured to receive broadband light beam 412 from the LSP light source 238 and split the broadband light beam 412 into a first broadband light beam 414 having a first light orientation 414A and a second broadband light beam 416 having a second light orientation 416A. For example, the beamsplitter 402 may split at or near a 1:1 ratio. For instance, each broadband light beam emanating from the beamsplitter 402 may be configured to be between 40 to 60% of the original broadband light beam 412.

The orientation of near fields in these two imaging paths of the first broadband light beam 414 and the second broadband light beam 416 are represented by two different dotted lines with arrows representing directionality.

In embodiments, the orientation (e.g., directionality) in one of the paths is inverted by using the inverting optics 408. In other words, one or more inverting optics 408 may be configured to invert the second light orientation 416A. The inverted orientation may be referred to as an inverted second light orientation 416B. For example, the one or more inverting optics 408 may include an image relay system as shown. By way of another example, the one or more inverting optics 408 may include prisms such as a Dove prism, Pechan prism, and/or the like. The one or more inverting optics 408 may include an image-reversing lens system. For instance, the one or more inverting optics 408 may include, two convex lenses 408A, 408B.

The one or more recombining optics 418 may be configured to recombine the first broadband light beam 414 having the first light orientation 414A and the second broadband light beam 416 having the inverted second light orientation 416B.

For instance, the one or more recombining optics 418 may include a second beamsplitter 404 configured to recombine the first broadband light beam 414 and the second broadband light beam 416 having the inverted second light orientation 416B. In this way, brighter or darker spots may be averaged out by splitting and then recombining the broadband light beams, with one half having an inverted orientation. For instance, the orientation may be defined relative to a direction of travel, such that a cross-sectional area normal to the direction of travel of a brightness distribution of the second broadband light beam 416 is inverted relative to the first broadband light beam 414 when recombined.

As noted, a net effect of recombining opposite orientations of near fields may be a reduction of random noise by averaging. Such an illumination source 128 may increase the usable size of a uniform area of a plasma image by changing the pointing directionality of one of the two imaging paths. If non-polarizing beam splitters are used, the system may incur a 50% loss of photons, which is likely still less than the typical losses in a homogenizer. However, since the LSP light source 238 may be unpolarized, embodiments herein may reduce the loss of light by using polarizing beam splitters. For example, the broadband light beam may be configured to be unpolarized. For instance, beamsplitter 402 and second beamsplitter 404 may, respectively, include a polarizing beam splitter 402 and a second polarizing beam splitter 404.

Additionally, some applications may benefit from, or even require, precise control of polarization of light at the illumination beam collection aperture 224. In embodiments, the illumination source 128 includes one or more compensating devices 420 placed in at least one of the imaging paths of the broadband light beams 414, 416 and configured to alter the relative strength of at least one of the first broadband light beam 414 or the second broadband light beam 416. For example, the one or more compensating devices 420 may include filters, wave plates, polarizers, and/or the like.

In embodiments, the illumination source 128 includes additional optics. For example, the additional optics may include additional reflectors 406, 410 configured to direct the second broadband light beam 416 along its path.

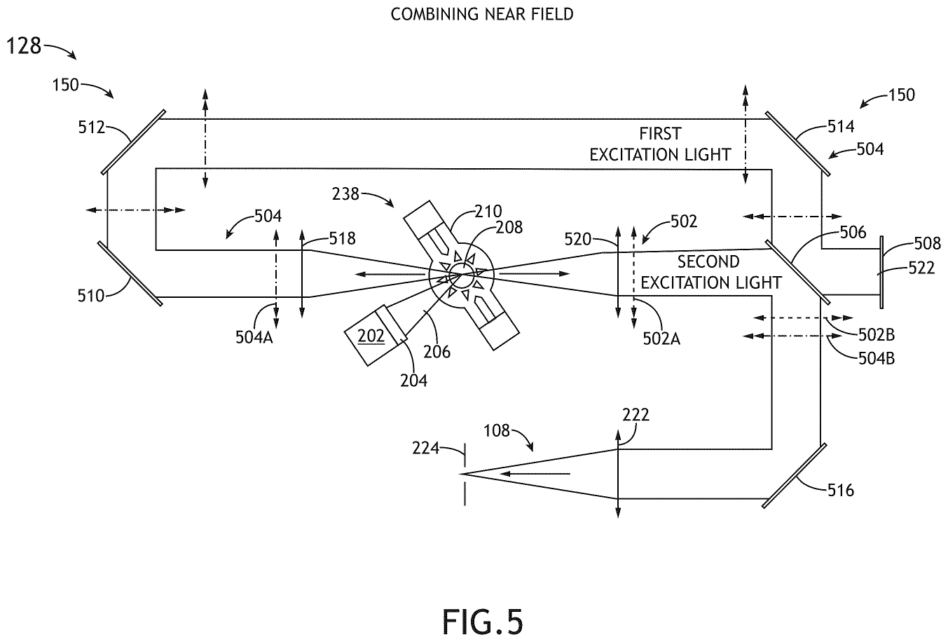

FIG. 5 illustrates a schematic view of the illumination source 128 configured for imaging a plasma twice and combining a first and second broadband light beam for improved uniformity, in accordance with one or more embodiments of the present disclosure. Rather than imaging the LSP light source 238 once, splitting a single beam, inverting one of the split beams, and recombining the split beams as illustrated in FIG. 4, FIG. 5 illustrates imaging the LSP light source twice to generate two beams. These two broadband light beams may be combined to create an averaged out and more uniform broadband light beam.

In embodiments, the illumination source 128 is configured to image the plasma 208 from more than one direction, such as two different directions. For instance, the two directions may be angled outwards at opposing sides of the gas containment structure 210 such that light is collected from the plasma 208 at two distinct, non-overlapping areas.

Benefits may include, but are not limited to, increasing the total brightness output due to more than one imaging operation being combined to provide twice, or nearly twice the brightness. Another benefit may include being more readily able to manipulate and/or increase a usable area of uniform brightness, such as an area of brightness as measured in a pupil plane for a desired brightness level. As the total brightness increases, a given brightness level may be achievable over a larger area.

In embodiments, the illumination source 128 includes one or more first optics 518. The one or more first optics 518 may be configured to receive the first broadband light beam 504. This may be referred to as a first imaging operation. For example, the one or more first optics 518 may include a lens 518 (e.g., convex lens) configured to collect a first broadband light beam 504 from the LSP light source 238. The one or more first optics may further include reflectors 510, 512, 514, and/or the like for directing the first broadband light beam 504 to be combined with the second broadband light beam 502.

In embodiments, the illumination source 128 includes one or more second optics 520. The one or more second optics 520 may be configured to receive the second broadband light beam 502. This may be referred to as a second imaging operation. The second broadband light beam 502 may be distinct from the first broadband light beam 504 but may be received from the same LSP light source 238 as the first broadband light beam 504.

The illumination source 128 may include one or more combining optics 506. The one or more combining optics 506 may be configured to combine the first broadband light beam 504 and the second broadband light beam 502. For example, the one or more combining optics 506 may include a beamsplitter 506. For instance, the beamsplitter 506 may be positioned and configured to receive the first broadband light beam 504 and the second broadband light beam 502.

A split-off portion 522 of broadband light beam that would otherwise be discarded from the beamsplitter 506 may be configured, via a redirecting element 508, to be redirected back into the beamsplitter 506 and back through the plasma 208 and throughout the illumination source 128. This may improve efficiency by reusing the light. The redirecting element 508 may include a reflecting element, such as a mirror.

The illumination source 128 may include a reflector 516 to direct the combined broadband light beam 108 towards the illumination beam collection aperture 224.

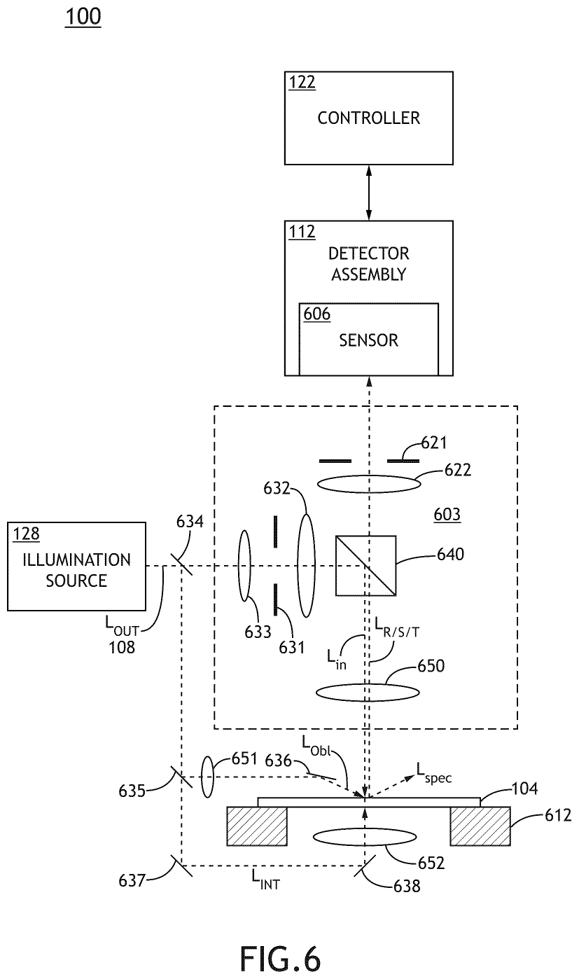

FIG. 6 illustrates a simplified block diagram of a characterization system 100, in accordance with one or more embodiments of the present disclosure.

The characterization system 100 may be configured as an inspection system or a metrology system for inspecting a sample 104 or acquiring optical metrology measurements from the sample 104. The characterization system 100 may include a semiconductor fabrication system. For example, the characterization system 100 may include a fabrication system configured to cut, drill, or ablate material from sample 104, or to expose a pattern onto photoresist on sample 104.

The sample 104 may include any sample known in the art such as, but not limited to, a wafer, reticle, photomask, or the like. In embodiments, the sample 104 may be disposed on a stage assembly 612 to facilitate movement of the sample 104. The stage assembly 612 may include any stage assembly known in the art including, but not limited to, an X-Y stage, an R-θ stage, and the like. In embodiments, the stage assembly 612 is capable of adjusting the height of the sample 104 during inspection to maintain focus on the sample 104. In embodiments, a lens such as objective lens 650 may be moved up and down during inspection to maintain focus on the sample 104.

In embodiments, the characterization system 100 includes an illumination source 128 that generates the broadband light beam 108. For example, the illumination source 128 may include any illumination source 128 described herein.

In embodiments, the characterization system 100 includes one or more optical components such as, but not limited to, beam splitters, mirrors, lenses, apertures and waveplates that are configured to condition and direct the broadband light beam 108 to sample 104. The optical components may be configured to illuminate an area, a line, or a spot on sample 104. In embodiments, the beam splitter or mirror 634, mirrors 637, 638 and lens 652 are configured to illuminate sample 104 from below so as to enable inspection or measurement of sample 104 by transmitting light L_{INT} through the sample 104. In embodiments, beam splitters or mirrors 634 and 635, mirror 636 and lens 651 are configured to illuminate sample 104 with light at an oblique angle of incidence L_{Obl}, for example at an angle of incidence greater than 60° relative to a normal to the sample surface. In this embodiment, the specularly reflected light L_{Spec} may be blocked or discarded rather than collected. In embodiments, optics 603 are collectively configured to direct illumination light L_{IN} to the top surface of sample 104. For example, beamsplitter 640 may direct illumination light L_{IN} to the top surface of sample 104.

When the sample 104 is illuminated in one or more of the above-described modes, the optics 603 are also configured to collect light L_{R/S/T} reflected, scattered, diffracted, transmitted and/or emitted from the sample 104 and direct and focus the light L_{R/S/T} to sensor 606 of the detector assembly 112. It is noted herein that sensor 606 and the detector assembly 112 may include any sensor 606 known in the art. For example, the sensor 606 may include, but is not limited to, a charge-coupled device (CCD) detector, a complementary metal oxide semiconductor (CMOS) detector, a time-delay integration (TDI) detector, a photomultiplier tube (PMT), an avalanche photodiode (APD), a line sensor, an electron-bombarded line sensor, or the like. The detector assembly 112 may be communicatively coupled to the controller 122. The detector assembly 112 may also include active or passive optical elements. For example, the detector assembly 112 may include a spectrograph, polarizers, waveplates, optical filters, and/or the like configured to disperse the broadband light beam.

The controller 122 may be configured to store and/or analyze data from detector assembly 112 under control of program instructions stored on the memory device 126. The controller 122 may be further configured to control other elements of characterization system 100 such as stage assembly 612, illumination source 128 and optics 603.

In embodiments, the optics 603 includes an illumination tube lens 633. The illumination tube lens 632 may be configured to image an illumination pupil aperture 631 to a pupil within an objective lens 650. For example, the illumination tube lens 632 may be configured such that the illumination pupil aperture 631 and the pupil within the objective lens 650 are conjugate to one another. In embodiments, the illumination pupil aperture 631 may be configurable by switching different apertures into the location of illumination pupil aperture 631. In embodiments, the illumination pupil aperture 631 may be configurable by adjusting a diameter or shape of the opening of the illumination pupil aperture 631. In this regard, the sample 104 may be illuminated by different ranges of angles depending on the characterization (e.g., measurement or inspection) being performed under control of the controller 122. The illumination pupil aperture 631 may also include a polarizing element to control the polarization state of the illumination light L_{IN}.

In embodiments, the one or more optical elements 603 include a collection tube lens 622. For example, the collection tube lens 622 may be configured to image the pupil within the objective lens 650 to a collection pupil aperture 621. For instance, the collection tube lens 622 may be configured such that the collection pupil aperture 621 and the pupil within the objective lens 650 are conjugate to one another. In embodiments, the collection pupil aperture 621 may be configurable by switching different apertures into the location of collection pupil aperture 621. In embodiments, the collection pupil aperture 621 may be configurable by adjusting a diameter or shape of the opening of collection pupil aperture 621. In this regard, different ranges of angles of illumination reflected or scattered from the sample 104 may be directed to detector assembly 112 under control of the controller 122. The collection pupil aperture 621 may also include a polarizing element so that a specific polarization of light L_{R/S/T} can be selected for transmission to sensor 606.

The various optical elements and operating modes depicted in FIG. 6 are merely to illustrate how illumination source 128 may be used in characterization system 100 and are not intended to limit the scope of the present disclosure. A practical characterization system 100 may implement a subset or a superset of the modes and optics depicted in FIG. 6. Additional optical elements and subsystems may be incorporated as needed for a specific application.

Referring again to FIGS. 1-6, various components are described in greater detail in accordance with one or more embodiments of the present disclosure.

The one or more processors 124 of the controller 122 may include any processor or processing element known in the art. Note that controller 212 is not necessarily the same type of controller as controller 122.

For the purposes of the present disclosure, the term “processor” or “processing element” may be broadly defined to encompass any device having one or more processing or logic elements (e.g., one or more micro-processor devices, one or more application specific integrated circuit (ASIC) devices, one or more field programmable gate arrays (FPGAs), or one or more digital signal processors (DSPs)). In this sense, the one or more processors 124 may include any device configured to execute algorithms and/or instructions (e.g., program instructions stored in memory). In embodiments, the one or more processors 124 may be embodied as a desktop computer, mainframe computer system, workstation, image computer, parallel processor, networked computer, or any other computer system configured to execute a program configured to operate or operate in conjunction with the system 100, as described throughout the present disclosure. Moreover, different subsystems of the system 100 may include a processor or logic elements suitable for carrying out at least a portion of the steps described in the present disclosure. Therefore, the above description should not be interpreted as a limitation on the embodiments of the present disclosure but merely as an illustration. Further, the steps described throughout the present disclosure may be carried out by a single controller or, alternatively, multiple controllers. Additionally, the controllers 212, 122 may include one or more controllers housed in a common housing or within multiple housings. In this way, any controller or combination of controllers may be separately packaged as a module suitable for integration into system 100. Further, the controller 122 may analyze or otherwise process data received from the one or more detector assemblies 112 and feed the data to additional components within the system 100 or external to the system 100.

Further, the memory device 126 may include any storage medium known in the art suitable for storing program instructions executable by the associated one or more processors 124. For example, the memory device 126 may include a non-transitory memory medium. As an additional example, the memory device 126 may include, but is not limited to, a read-only memory, a random-access memory, a magnetic or optical memory device (e.g., disk), a magnetic tape, a solid-state drive and the like. It is further noted that memory device 126 may be housed in a common controller housing with the one or more processors 124.

In this regard, the controller 122 may execute any of various processing steps. For example, the controller 122 may be configured to generate control one or more signals to direct or otherwise control the optical sub-system 102, or any components thereof. For instance, the controller 122 may be configured to receive one or more signals corresponding to the one or more signals from the one or more detector assemblies 112. By way of another example, the controller 122 may generate correctables for one or more additional fabrication tools as feedback and/or feed-forward control of the one or more additional fabrication tools based on overlay measurements from the optical sub-system 102.

It is noted herein that the one or more components of system 100 may be communicatively coupled to the various other components of system 100 in any manner known in the art. For example, the one or more processors 124 may be communicatively coupled to each other and other components via a wireline (e.g., copper wire, fiber optic cable, and the like) or wireless connection (e.g., RF coupling, IR coupling, WiMax, Bluetooth, 3G, 4G, 4G LTE, 5G, and the like). By way of another example, the controller 122 may be communicatively coupled to one or more components of optical sub-system 102 via any wireline or wireless connection known in the art.

In embodiments, the one or more processors 124 may include any one or more processing elements known in the art. In this sense, the one or more processors 124 may include any microprocessor-type device configured to execute software algorithms and/or instructions. In embodiments, the one or more processors 124 may consist of a desktop computer, mainframe computer system, workstation, image computer, parallel processor, or other computer system (e.g., networked computer) configured to execute a program configured to operate the system 100, as described throughout the present disclosure. It should be recognized that the steps described throughout the present disclosure may be carried out by a single computer system or, alternatively, multiple computer systems. Furthermore, it should be recognized that the steps described throughout the present disclosure may be carried out on any one or more of the one or more processors 124. In general, the term “processor” may be broadly defined to encompass any device having one or more processing elements, which execute program instructions from memory 126. Moreover, different subsystems of the system 100 may include processor or logic elements suitable for carrying out at least a portion of the steps described throughout the present disclosure. Therefore, the above description should not be interpreted as a limitation on the present disclosure but merely an illustration.

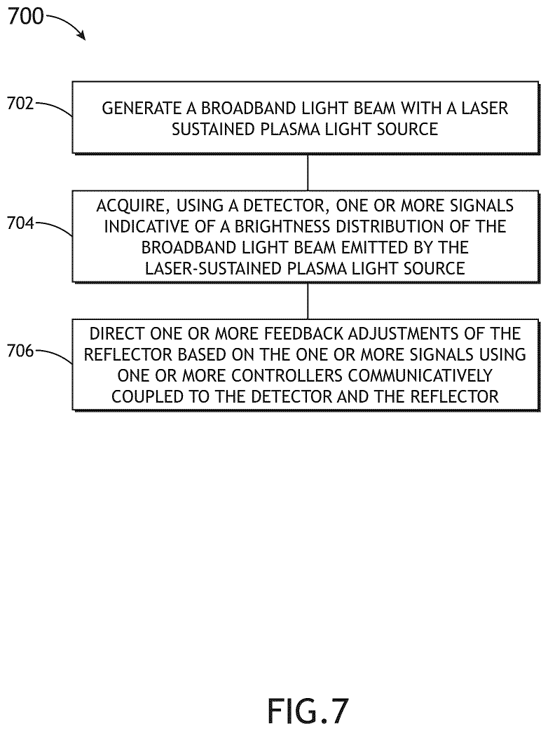

FIG. 7 illustrates a process flow diagram depicting a method 700 for actively reducing the noise or increasing the uniformity of illumination, in accordance with one or more embodiments of the present disclosure. It is noted that the embodiments and enabling technologies described previously herein in the context of the illumination source 128 should be interpreted to extend to the method 700. It is further noted herein that the steps of method 700 may be implemented all or in part by illumination source 128. It is further recognized, however, that the method 700 is not limited to the illumination source 128 in that additional or alternative system-level embodiments may carry out all or part of the steps of method 700.

In step 702, a broadband light beam 226 is generated with a LSP light source 238. For example, the power supply 202 may supply electrical power to a laser source 204 to sustain a plasma 208 and a collection optic 220 may be used to form the broadband light beam 226.

In step 704, one or more signals indicative of the brightness distribution of the broadband light beam 226 emitted by the LSP light source 238 are acquired using a detector 218. For example, referring to FIGS. 2 and 3, the detector 218 may capture one or more signals indicative of the brightness distribution of the broadband light beam 226 emitted by the LSP light source 238. For example, the one or more signals may be data received from the detector 218 by controller 212.

In step 706, one or more feedback adjustments of the adjustable reflector 234 are directed based on the one or more signals using the one or more controllers 212 communicatively coupled to the detector 218 and the adjustable reflector 234. For example, adjustments may be made to direct the reflection of the broadband light beam 226. For example, controller 212 may be configured to be used in a feedback control loop to control the adjustments to the adjustable reflector 234.

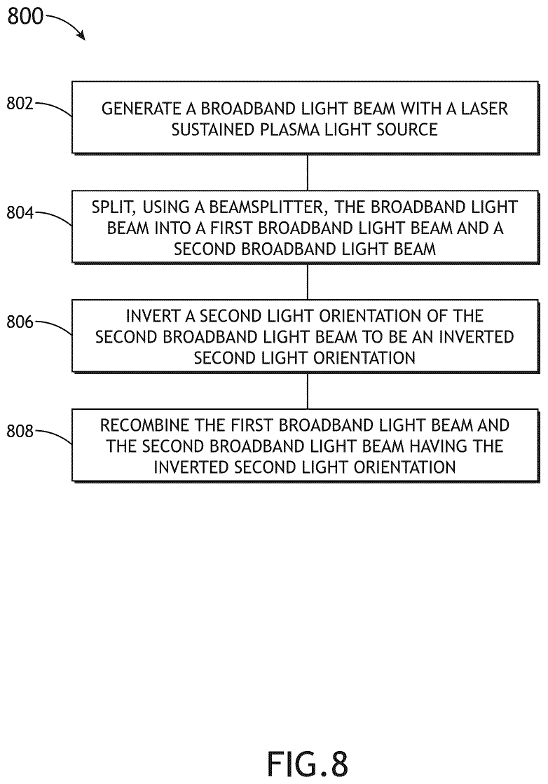

FIG. 8 illustrates a process flow diagram depicting a method 800 for improving uniformity of illumination, in accordance with one or more embodiments of the present disclosure. It is noted that the embodiments and enabling technologies described previously herein in the context of the illumination source 128 should be interpreted to extend to the method 800. It is further noted herein that the steps of method 800 may be implemented all or in part by illumination source 128. It is further recognized, however, that the method 800 is not limited to the illumination source 128 in that additional or alternative system-level embodiments may carry out all or part of the steps of method 800.

In step 802, a broadband light beam 412 is generated with a laser sustained plasma light source 238. For example, the power supply 202 may supply electrical power to a laser source 204 to sustain a plasma 208.

In step 804, the broadband light beam 412 from the LSP light source 238 is split into a first broadband light beam 414 and a second broadband light beam 416 using a beamsplitter 402.

In step 806, a second light orientation 416A of the second broadband light beam 416 is inverted to be an inverted second light orientation 416B. For example, inverting optics 408 may be used to achieve the inverted second light orientation 416B.

In step 808, the first broadband light beam 414 and the second broadband light beam 416 having the inverted second light orientation 416B are recombined. For example, recombining optics 418 may be used to merge the light paths.

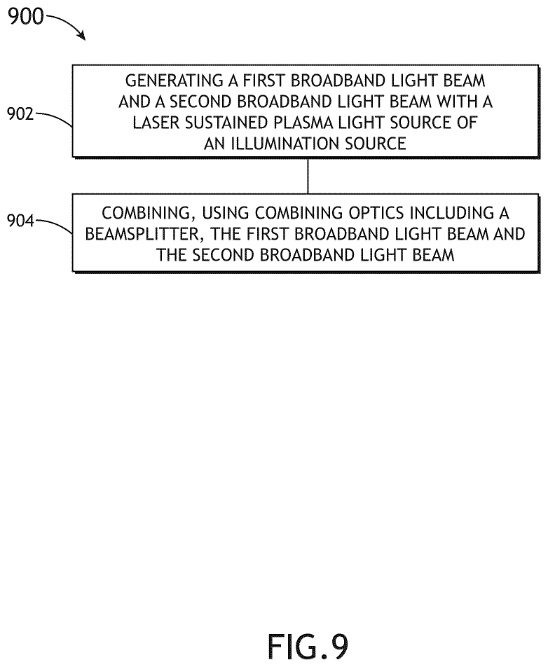

FIG. 9 illustrates a process flow diagram depicting a method 900 for improving uniformity of illumination, in accordance with one or more embodiments of the present disclosure. It is noted that the embodiments and enabling technologies described previously herein in the context of the illumination source 128 should be interpreted to extend to the method 900. It is further noted herein that the steps of method 900 may be implemented all or in part by illumination source 128. It is further recognized, however, that the method 900 is not limited to the illumination source 128 in that additional or alternative system-level embodiments may carry out all or part of the steps of method 900.

In step 902, a first broadband light beam 504 and a second broadband light beam 502 are generated with the LSP light source 238 of the illumination source 128. For example, the LSP light source 238 may be a single source used to generate enough broadband light for two or more separate and distinct beams of broadband light.

In step 904, the first broadband light beam 504 and the second broadband light beam 502 are combined. The combined beam may be referred to as a single combined broadband light beam. For example, additional reflectors 510, 512, 514 may aide in aligning the two light broadband light beams 502, 504.

In an optional step, the sample 104 may be illuminated with the single combined broadband light beam. For example, an overlay measurement, an inspection measurement, and/or a metrology measurement may be acquired from the sample 104 using the single combined broadband light beam.

For example, the combining may be configured so that the second broadband light beam 502 has an inverted second light orientation 502B relative to an original orientation of the first broadband light beam 504. For example, the first broadband light beam 504 may have an original first light orientation 504A relative to an original second light orientation 502A of the second broadband light beam 502. When combined, this relationship may be inverted such that the inverted second light orientation 502B is inverted relative to the first light orientation 504B.

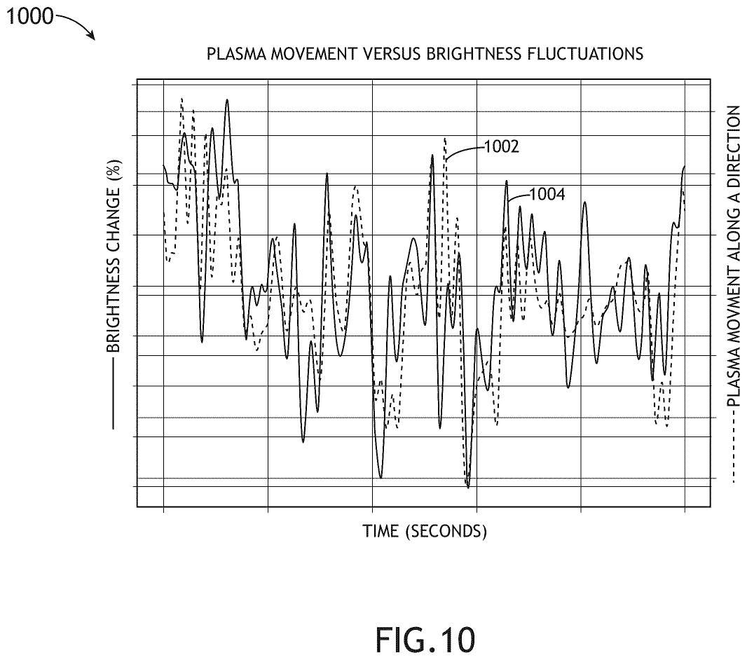

FIG. 10 illustrates a data graph 1000 of plasma movement 1002 and brightness fluctuations 1004 over time, in accordance with one or more embodiments of the present disclosure.

As shown, the plasma movement 1002 of a centroid of the plasma over time is strongly correlated to measured brightness fluctuations 1004. It is contemplated herein that this strong correlation may be addressed by embodiments herein to provide improved uniformity, increased peak brightness, and reduced fluctuations.

One skilled in the art will recognize that the herein described components, operations, devices, objects, and the discussion accompanying them are used as examples for the sake of conceptual clarity and that various configuration modifications are contemplated. Consequently, as used herein, the specific exemplars set forth and the accompanying discussion are intended to be representative of their more general classes. In general, use of any specific exemplar is intended to be representative of its class, and the non-inclusion of specific components (e.g., operations), devices, and objects should not be taken as limiting.

Those having skill in the art will appreciate that there are various vehicles by which processes and/or systems and/or other technologies described herein can be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; alternatively, if flexibility is paramount, the implementer may opt for a mainly software implementation; or, yet again alternatively, the implementer may opt for some combination of hardware, software, and/or firmware. Hence, there are several possible vehicles by which the processes and/or devices and/or other technologies described herein may be effected, none of which is inherently superior to the other in that any vehicle to be utilized is a choice dependent upon the context in which the vehicle will be deployed and the specific concerns (e.g., speed, flexibility, or predictability) of the implementer, any of which may vary.

The previous description is presented to enable one of ordinary skill in the art to make and use the invention as provided in the context of a particular application and its requirements. Various modifications to the described embodiments will be apparent to those with skill in the art, and the general principles defined herein may be applied to other embodiments. Therefore, the present disclosure is not intended to be limited to the particular embodiments shown and described, but is to be accorded the widest scope consistent with the principles and novel features herein disclosed.

With respect to the use of substantially any plural and/or singular terms herein, those having skill in the art can translate from the plural to the singular and/or from the singular to the plural as is appropriate to the context and/or application. The various singular/plural permutations are not expressly set forth herein for sake of clarity.

All of the methods described herein may include storing results of one or more steps of the method embodiments in memory. The results may include any of the results described herein and may be stored in any manner known in the art. The memory may include any memory described herein or any other suitable storage medium known in the art. After the results have been stored, the results can be accessed in the memory and used by any of the method or system embodiments described herein, formatted for display to a user, used by another software module, method, or system, and the like. Furthermore, the results may be stored “permanently,” “semi-permanently,” temporarily,” or for some period of time. For example, the memory may be random access memory (RAM), and the results may not necessarily persist indefinitely in the memory.

It is further contemplated that each of the embodiments of the method described above may include any other step(s) of any other method(s) described herein. In addition, each of the embodiments of the method described above may be performed by any of the systems described herein.

The herein described subject matter sometimes illustrates different components contained within, or connected with, other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “connected,” or “coupled,” to each other to achieve the desired functionality, and any two components capable of being so associated can also be viewed as being “couplable,” to each other to achieve the desired functionality. Specific examples of couplable include but are not limited to physically mateable and/or physically interacting components and/or wirelessly interactable and/or wirelessly interacting components and/or logically interacting and/or logically interactable components.

Furthermore, it is to be understood that the invention is defined by the appended claims. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” and the like). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, and the like” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, and the like). In those instances where a convention analogous to “at least one of A, B, or C, and the like” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, and the like). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

It is believed that the present disclosure and many of its attendant advantages will be understood by the foregoing description, and it will be apparent that various changes may be made in the form, construction and arrangement of the components without departing from the disclosed subject matter or without sacrificing all of its material advantages. The form described is merely explanatory, and it is the intention of the following claims to encompass and include such changes. Furthermore, it is to be understood that the invention is defined by the appended claims.

We claim:

1. An illumination source comprising:
a laser sustained plasma light source configured to generate a broadband light beam;
a detector;
a set of optics comprising an adjustable reflector, wherein the adjustable reflector is configured to receive and reflect the broadband light beam emitted from the laser sustained plasma light source,
wherein the detector is configured to detect a brightness distribution of the broadband light beam emitted by the laser sustained plasma light source along one or more directions, wherein the brightness distribution of the laser sustained plasma light source corresponds to fluctuations within a plasma of the laser sustained plasma light source; and
one or more controllers communicatively coupled to the detector and the adjustable reflector and configured to:
acquire, via the detector, one or more signals indicative of the brightness distribution of the broadband light beam emitted by the laser sustained plasma light source; and
direct one or more feedback adjustments of the adjustable reflector based on the one or more signals.

2. The illumination source of claim 1, wherein the illumination source comprises a beamsplitter configured to receive the broadband light beam from the laser sustained plasma light source, and split and direct less than 50% of the broadband light beam to the detector.

3. The illumination source of claim 1, wherein the illumination source comprises optical elements configured to collect the broadband light beam emitted from the laser sustained plasma light source from multiple angles and direct a portion of that light to the detector.

4. The illumination source of claim 1, wherein the one or more feedback adjustments comprise:
adjusting at least one of a shape or a direction of the adjustable reflector based on the one or more signals indicative of the brightness distribution of the broadband light beam along the one or more directions.

5. The illumination source of claim 4, wherein the adjusting is configured to maintain, via continuous feedback, a centroid of the brightness distribution at a particular position of a cross-sectional distribution of the broadband light beam.

6. The illumination source of claim 1, wherein the adjustable reflector comprises an aimable reflector, wherein the directing of the one or more feedback adjustments of the adjustable reflector based on the one or more signals comprises:
adjusting a direction of the aimable reflector using one or more actuators.

7. The illumination source of claim 1, wherein the adjustable reflector comprises a deformable mirror reflector, wherein the directing of the one or more feedback adjustments of the adjustable reflector based on the one or more signals comprises:
adjusting a reflecting surface shape of the deformable mirror reflector.

8. The illumination source of claim 1, wherein the adjustable reflector comprises a digital micro-mirror device (DMD) comprising a plurality of DMD reflecting elements in an array, wherein the directing of the one or more feedback adjustments of the adjustable reflector based on the one or more signals comprises:
selectively actuating the plurality of DMD reflecting elements.

9. The illumination source of claim 1, wherein the one or more directions comprise two or more directions.

10. The illumination source of claim 9, wherein the detector comprises a diode array detector.

11. The illumination source of claim 9, wherein the detector comprises a quad-diode detector.

12. The illumination source of claim 1, wherein the one or more controllers comprise one or more proportional-integral-derivative (PID) controllers configured for the directing of the one or more feedback adjustments based on the one or more signals.

13. The illumination source of claim 1, wherein the one or more controllers are further configured to direct one or more non-reflector feedback adjustments comprising:
an adjustment of a power supply configured to adjust a power level supplied to a laser source of the laser sustained plasma light source based on the one or more signals.

14. An illumination source comprising:
a laser sustained plasma light source configured to generate a broadband light beam; and
a set of optics comprising:
a beamsplitter configured to receive the broadband light beam from the laser sustained plasma light source and split the broadband light beam into a first broadband light beam having a first light orientation and a second broadband light beam having a second light orientation;
one or more inverting optics configured to invert the second light orientation of the second broadband light beam to be an inverted second light orientation; and
one or more recombining optics configured to recombine the first broadband light beam having the first light orientation and the second broadband light beam having the inverted second light orientation.

15. The illumination source of claim 14, wherein the one or more recombining optics comprise a second beamsplitter configured to recombine.

16. The illumination source of claim 14, further comprising;
a compensating device placed in a path of at least one of the first broadband light beam or the second broadband light beam, wherein the compensating device is configured to alter a relative strength of at least one of the first broadband light beam or the second broadband light beam.

17. An illumination source comprising:
a laser sustained plasma light source configured to generate a first broadband light beam and a second broadband light beam; and
a set of optics comprising:
one or more first optics configured to receive the first broadband light beam;
one or more second optics configured to receive the second broadband light beam, wherein the second broadband light beam is distinct from the first broadband light beam but configured to be received from a same laser sustained plasma light source as the first broadband light beam; and
one or more combining optics configured to combine the first broadband light beam and the second broadband light beam.

18. The illumination source of claim 17, wherein the one or more combining optics comprise a beamsplitter.

19. The illumination source of claim 18, wherein a split-off portion otherwise discarded from the beamsplitter is configured, via a redirecting element, to be redirected back into the beamsplitter, and back through a plasma of the laser sustained plasma light source.

20. A characterization system comprising:
an illumination source configured to provide a broadband light beam to a sample; and
a detector assembly configured to image the sample,
wherein the illumination source comprises:
a laser sustained plasma light source configured to generate the broadband light beam;
a detector;
a set of optics comprising an adjustable reflector, wherein the adjustable reflector is configured to receive and reflect the broadband light beam emitted from the laser sustained plasma light source,
wherein the detector is configured to detect a brightness distribution of the broadband light beam emitted by the laser sustained plasma light source along one or more directions, wherein the brightness distribution of the laser sustained plasma light source corresponds to fluctuations within a plasma of the laser sustained plasma light source; and
one or more controllers communicatively coupled to the detector and the adjustable reflector and configured to:
acquire, via the detector, one or more signals indicative of the brightness distribution of the broadband light beam emitted by the laser sustained plasma light source; and
direct one or more feedback adjustments of the adjustable reflector based on the one or more signals.

21. A characterization system configured to improve uniformity of illumination comprising:
an illumination source configured to provide broadband light beam to a sample; and
a detector assembly configured to image the sample,
wherein the illumination source comprises:
a laser sustained plasma light source configured to generate the broadband light beam; and
a set of optics comprising:
a beamsplitter configured to receive the broadband light beam from the laser sustained plasma light source and split the broadband light beam into a first broadband light beam having a first light orientation and a second broadband light beam having a second light orientation;
one or more inverting optics configured to invert the second light orientation of the second broadband light beam to be an inverted second light orientation; and
one or more recombining optics configured to recombine the first broadband light beam having the first light orientation and the second broadband light beam having the inverted second light orientation.

22. A characterization system configured to improve uniformity of illumination comprising:
an illumination source configured to provide broadband light to a sample; and
a detector assembly configured to image the sample,
wherein the illumination source comprises:
a laser sustained plasma light source configured to generate a first broadband light beam and a second broadband light beam; and
a set of optics comprising:
one or more first optics configured to receive the first broadband light beam;
one or more second optics configured to receive the second broadband light beam, wherein the second broadband light beam is distinct from the first broadband light beam but configured to be received from a same laser sustained plasma light source as the first broadband light beam; and
one or more combining optics configured to combine the first broadband light beam and the second broadband light beam.

23. A method comprising:
generating a broadband light beam with a laser sustained plasma light source of an illumination source;
acquiring, via a detector, one or more signals indicative of a brightness distribution of the broadband light beam emitted by the laser sustained plasma light source, wherein the brightness distribution is along one or more directions; and
directing, via one or more controllers communicatively coupled to the detector and an adjustable reflector, one or more feedback adjustments of the adjustable reflector based on the one or more signals.

24. A method comprising:
generating a broadband light beam with a laser sustained plasma light source of an illumination source;
splitting, via a beamsplitter of the illumination source, the broadband light beam into a first broadband light beam and a second broadband light beam;
inverting, via one or more inverting optics of the illumination source, a second light orientation of the second broadband light beam to be an inverted second light orientation; and
recombining, via recombining optics of the illumination source, the first broadband light beam and the second broadband light beam having the inverted second light orientation.

25. A method comprising:
generating a first broadband light beam and a second broadband light beam with a laser sustained plasma light source of an illumination source;
combining, via combining optics comprising a beamsplitter, the first broadband light beam and the second broadband light beam as a single combined broadband light beam; and
illuminating a sample with the single combined broadband light beam.
